(19) United States
(12) Patent Application Publication
(10) Pub. No.: US 2004/0201566 A1
(43) Pub. Date: Oct. 14, 2004

(54) Display apparatus having alterable penetrative index and reflective index and method of same

(76) Inventor: Hsien-Hsing Wu, Taichung (TW)

Correspondence Address: BIRCH STEWART KOLASCH & BIRCH, PO BOX 747, FALLS CHURCH, VA, 22040-0747, US

(21) Appl. No.: 10/412,224

(22) Filed: Apr. 14, 2003

(51) Int. Cl. G09G 3/36

(52) U.S. Cl. 345/102

(57) ABSTRACT

A display apparatus having an alterable penetrative index and reflective index and a method of same includes a primary display device and a back light module. A secondary display device is interposed between the primary display device and the back light module to function as a reflective plate. When the external light source is strong, the secondary display device directly reflects the light to the primary display device and the back light module is turned off to save electric power. When the external light source is weak, the reflective index of the secondary display device is adjusted to the minimum so that light provided by the back light module projects directly to the primary display device to achieve optimal utilization.

### FIELD OF THE INVENTION

The present invention relates to a display apparatus with an alterable penetrative index and reflective index and a method of achieving the same, and particularly to a display apparatus that has a greater reflective effect in a reflection mode and a greater penetrative index in a penetrative mode to save electric power consumption and enhance contrast.

### BACKGROUND OF THE INVENTION

Liquid crystal was first discovered more than one hundred years ago. In 1888 an Austrian botanist Friedrich Reinitzer discovered a chemical compound during separating and distilling molten cholesteryl benzoate. When the chemical compound was heated to 145.5° C., the solid compound was melt to become a white and semi-molten turbid fluid between the solid phase and the liquid phase. The state remains until the temperature reaches 178.5° C. Then it becomes a clear isotropic liquid. In 1889, a Germanic physicist O. Lehmann studied the chemical compound while researching phase transformation and thermal equilibrium. He discovered that under a polarized microscope, the viscous and white turbid semi-fluid chemical compound has an optical property of birefringence existing only in the anisotropic crystal, i.e. optical anistropic. Hence the crystal-like liquid was named liquid crystal.

The molecular structure of the liquid crystal is anisotropic. Hence the photoelectric effects it generates vary by different directions. I.e. the photoelectric properties such as dielectric coefficient and refractive index of the molecule of liquid crystal are anisotropic. Using these properties, the intensity of an incident light may be changed to form a gray grade which may be applied on display elements. In the properties of liquid crystal, the most important factors are the dielectric coefficient and refractive index. The dielectric coefficient is the orientation property of the liquid crystal molecule when subject to an electric field. The refractive index is an important parameter that affects the optical traveling path when light passes through the liquid crystal. Because of these properties, a voltage difference between two glass substrates may be used to control the orientation of the liquid crystal and consequently affect the light traveling direction to form different grays to display images.

The basic principle of LCD is to employ an upper glass substrate and a lower glass substrate to hold liquid crystals therebetween. Then two polarizers are used to clamp the upper and the lower glass substrates. The surfaces of the two glass substrates that are in contact with the liquid crystals are not smooth. They are formed with saw type grooves to allow the liquid crystals to be laid thereon in a neat and desired manner. The smooth surfaces would cause disordered arrangement of the liquid crystal molecules and result in light scattering and leakage. The glass substrates are plated with a layer of indium tin oxide (ITO) to enable the glass substrates to function as electrodes. The polarizer functions as a grid and blocks the component normal to the grid and allows only the component that is parallel with the grid to pass through. Hence when the grid angles of two polarizers are normal to each other, light is completely blocked without passing through. The liquid crystal display device employs this property to achieve the desired function. Liquid crystals are filled between the polarizers of the two grids that are normal to each other. Then an electric field is used to control the orientation of the liquid crystals to change the traveling direction of light. Different electric fields form different gray illuminations.

At present, the LCD device displays mainly by transforming reflection and penetration. When external light is strong, the external light projects onto a reflective plate in the LCD device. The reflective plate reflects the light to human eyes. When the external light is weak, a back light module resided in the LCD device projects light.

However, the reflective plate structure of the present LCD devices has a fixed reflective index. In the event that the reflective index is high, the penetrative index is low. On the other hand, when the penetrative index is high, the reflective index is low. In other words, if the reflective plate of the LCD device has a high reflective index, and when the external light is weak, the display device cannot obtain a desired contrast. If the reflective index of the reflective plate is low and the external light is strong, good contrast also cannot be achieved.

Therefore, a conventional display device usually has a greater reflective index. As a result, the illumination of the back light module also has to be made greater. Otherwise when the external light is weak, the desired contrast cannot be achieved. But increasing the illumination of the back light incurs a greater cost and electric power consumption. Thus the fixed reflective index has become the biggest disadvantage of the conventional reflective plate.

### SUMMARY OF THE INVENTION

Therefore the primary object of the invention is to resolve the aforesaid disadvantages. The invention includes a secondary display device between a primary display device and a back light module to serve as a reflective plate. When the external light is strong, it becomes the reflective plate providing a greater reflective index. When the external light is weak, the reflective index of the secondary display device may be adjusted to a minimum to allow the light provided by the back light module to be utilized most effectively. Thereby the cost of the back light module and electric power consumption may be reduced, and the contrast of the display device may be enhanced.

In order to achieve the foregoing objects, the method and apparatus of the invention includes a primary display device, a secondary display device and a back light module. When the external light is strong, the grid angles of the two polarizers in the secondary display device are normal to each other to prevent the light from passing through and to reflect directly on the secondary display device, thus it becomes a reflective plate of a high reflective index. Meanwhile, the back light module is turned off to save electric energy. When the external light is weak, the liquid crystal molecules of the secondary display device are driven by a voltage and turn, therefore light illumination passing through the secondary display device may be controlled to alter the reflective index and the refractive index. And light generated by the back light module can be used most effectively.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of the invention showing the operating condition when the external light is weak.

FIG. 2 is a schematic view of the invention showing the operating condition when the external light is strong.

### DESCRIPTION OF THE PREFERRED EMBODIMENT

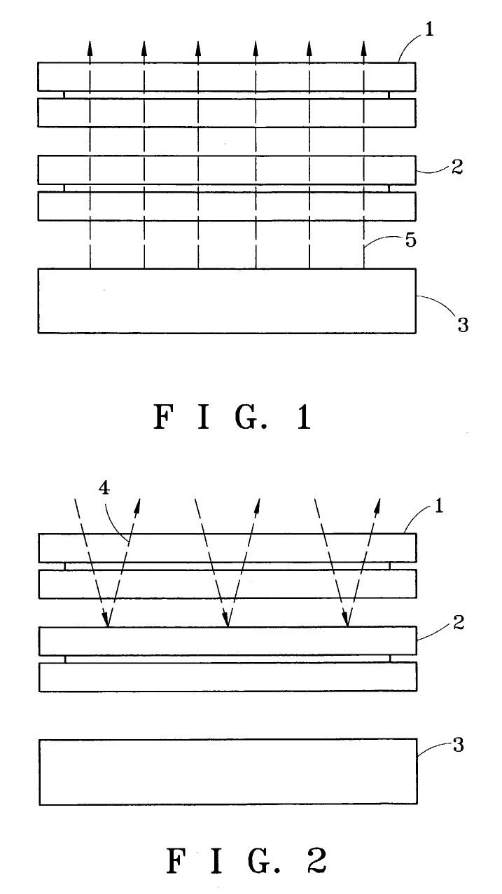

Referring to FIGS. 1 and 2, the invention mainly includes a primary display device 1, a secondary display device 2 and a back light module 3. The principle is that the secondary display device 2 is interposed between the primary display device 1 and the back light module 3 to function as a reflective plate. When the external light is strong, the secondary display device 2 directly reflects light 4 to the primary display device 1, and the back light module 3 is turned off to save electric power. When the external light is weak, the reflective index of the secondary display device 2 is adjusted to the minimum so that light 5 generated by the back light module 5 may directly project to the primary display device 1 to achieve most effective utilization.

The primary display device 1 may be constructed like a conventional one. It includes an upper glass substrate and a lower glass substrate to sandwich liquid crystals therebetween. Then two polaziers are provided to clamp the two glass substrates. The upper glass substrate has a color filter, while the lower glass substrate has a thin film transistor. Hence the glass substrates may function as electrodes. The primary display device 1 may be a TN (twisted nematic) LCD device, a CSTN (color super twisted nematic) LCD device, a TFT (thin film transistor) LCD device, or a semi-penetrative LCD device.

The secondary display device 2 is constructed same as the primary display device 1, and also may be a TN (twisted nematic) LCD device, a CSTN (color super twisted nematic) LCD device, a TFT (thin film transistor) LCD device, or a semi-penetrative LCD device. When the grid angles of the two polarizers in the secondary display device 2 are normal to each other, and a voltage is not applied on the secondary display device 2, light 4 cannot pass through the secondary display device 2. Instead, the light 4 is directly reflected. Thus the secondary display device 2 functions as a reflective plate of a high reflective index. When a voltage is applied on the secondary display device 2, the liquid crystal molecules of the secondary display device 2 are driven by the voltage and turn, therefore light illumination passing through the secondary display device 2 may be controlled to alter the reflective index and the refractive index.

The back light module 3 may be constructed like a conventional one, and include a cold cathode fluorescent lamp (CCFL), light emitting diode (LED), reflective plate, light directing plate, diffusion plate and prism sheet, etc. The CCFL is the primary light generating element. The light directing plate distributes the light. The reflective plate confines the light to travel in the direction towards the display device. The prism sheet and the diffusion plate distribute the light evenly to various areas to provide the display device a desired illumination.

When the external light is strong, the grid angles of the two polarizers (not shown in the drawings) in the secondary display device 2 are normal to each other. Light 4 cannot pass through the secondary display device 2. Instead, the light 4 is reflected directly on the secondary display device to the primary display device 1.

Thus the secondary display device becomes a reflective plate of a high reflective index. Meanwhile, the back light module 3 is turned off to save electric energy. When the external light is weak, the liquid crystal molecules of the secondary display device 2 are driven by a voltage and turn, therefore illumination of light 5 passing through the secondary display device 2 may be controlled to alter the reflective index and the refractive index. And the light 5 generated by the back light module 3 may be used most effectively.

What is claimed is:

1. A display apparatus having an alterable penetrative index and an alterable reflective index, comprising:
a back light module for emitting light;
a secondary display device located on the back light module to function as a reflective plate; and
a primary display device located on the secondary display device for receiving the light emitted from the back light module or an external light source, and being driven by a voltage to form illumination of different gray grades;
wherein the back light module is turned off when the external light source is strong and the secondary display device directly reflects the light of the external light source to the primary display device for saving electric power;
wherein the secondary display device is driven by another voltage when the external light source is weak to reduce the reflective index of the secondary display device to a minimum value so that the light provided by the back light module projects directly to the primary display device to achieve optimal utilization.

2. The display apparatus of claim 1, wherein the primary display device and the secondary display device are twisted nematic liquid crystal display devices.

3. The display apparatus of claim 1, wherein the primary display device and the secondary display device are color super twisted nematic liquid crystal display devices.

4. The display apparatus of claim 1, wherein the primary display device and the secondary display device are thin film transistor liquid crystal display devices.

5. The display apparatus of claim 1, wherein the primary display device and the secondary display device are semi-penetrative liquid crystal display devices.

6. A method for altering the penetrative index and the reflective index of a display apparatus which consists of a back light module and a primary display device which has liquid crystals driven by a voltage for turning to control light provided by the back light module to pass through the primary display device, comprising:
providing a secondary display device between the primary display device and the back light module to function as a reflective plate;
turning off the back light module when an external light source is strong so that the secondary display device directly reflects light from the external light source to the primary display device to save electric power; and
applying a voltage to drive the secondary display device when the external light source is weak to reduce the reflective index of the secondary display device to a minimum value so that the light provided by the back light module directly projects to the primary display device to achieve optimal utilization.
